(19) United States
(12) Patent Application Publication
(10) Pub. No.: US 2019/0130466 A1
(43) Pub. Date: May 2, 2019

(54) EXCHANGE FOR BUYING AND SELLING GOODS OR SERVICES

(71) Applicant: Gururaj Krishnan, Holmdel, NJ (US)

(72) Inventor: Gururaj Krishnan, Holmdel, NJ (US)

(21) Appl. No.: 16/178,671

(22) Filed: Nov. 2, 2018

Related U.S. Application Data
(60) Provisional application No. 62/580,650, filed on Nov. 2, 2017.

(51) Int. Cl. G06Q 30/06

(52) U.S. Cl. CPC G06Q 30/0619; G06Q 30/0639

(57) ABSTRACT

Methods and systems for trading goods between sellers and buyers in an open and transparent exchange.

### FIELD OF THE INVENTION

The present invention relates generally to methods and systems for exchanging goods, particularly for exchanging fungible goods, preferably through an internet marketplace. The methods and systems disclosed herein are particularly suitable for exchanging produce and other groceries.

### BACKGROUND OF THE INVENTION

Today's consumer faces multiple problems with online retailing. If a consumer knows a product to buy, the consumer will often search for the product on online retail web sites which then return a long list of matching items sold by various sellers at different prices. The consumer will then pick which seller to buy from after doing best price and time-to-arrive calculations. This process is tiresome to the buyer, who is merely interested in purchasing a good for the best price and/or fastest delivery time. It also creates market inefficiencies as to price.

One type of good that suffers greatest from the lack of market transparency and other market inefficiencies is fresh produce. Fresh produce is transacted and consumed every day in small quantities. Consumers often lack the time and information to search for a suitable seller. Compounding this problem is the fact that for the average consumer, fresh produce is often purchased using nominal amounts of money compared to large-scale financial transactions. Because the financial amount of the transactions is small, there is not enough interest in listing fungible goods over online retail markets. As a result, these small amounts cannot be delivered reliably to the customers under the current online retail method in which the online retailer employs their shipping methods from source to destination.

In addition, the current model for buying and selling produce suffers from several issues. For example, even after receiving the produce, some traders delay payment to farmers for weeks or months, or provide incomplete payments at the time of sale. In addition, to avoid taxes, some traders do not give slips to sellers making it difficult for the seller to prove his income to get loans from banks. Furthermore, middlemen in the transaction increase costs that are passed to the buyer in the form of higher prices and to the seller in the form of lost revenue; Sellers also often only receive 25% of the retail price of a good. During times of peak volume, when wholesalers make purchases at low prices they do not drastically reduce these prices to final consumers. Conversely, during times of low volume, when consumer prices are high, the sellers do not get higher returns on their goods.

Accordingly, there is a need in the art for a marketplace, preferably operated on the internet, that can operate as a platform for the purchase, sale, liquidation, and quality inspection of physical goods, such as fresh produce, or services, such as care or maintenance provided in the home. Preferably this online marketplace matches buyers and sellers based on good identity, price, location, good quality/quantity, delivery distance, and delivery time so that fungible goods can be transmitted predictably, cost-effectively, and in a timely manner. Any system or method described herein for exchanging goods is also contemplated as being suitable for exchanging services.

### SUMMARY OF THE INVENTION

The present invention is directed generally to methods of exchanging goods that improve the supply chain, particularly an agricultural supply chain, by separating procurement, pricing, and fulfillment into independent practices.

In an embodiment, the present invention is directed to a method of exchanging goods that includes the steps of:
(a) receiving a sell request for a good, wherein the sell request includes, but is not limited to, a first good identifier and a sell location identifier,
(b) receiving a buy request for the good, wherein the buy request includes, but is not limited to, a second good identifier and a buy location identifier, and
(c) determining a match of the sell request and the buy request if (i) the first good identifier is the same as the second good identifier and (ii) the sell location identifier is the same as the buy location identifier.

In a preferred embodiment, the method above is performed by a computer system over a network by the steps of:
(a) receiving over the network in the computer system a sell request for a good, wherein the sell request is encoded with data that includes, but is not limited to, a first good identifier and a sell location identifier,
(b) receiving over the network in the processor of the computer system a buy request for the good, wherein the buy request is encoded with data that includes, but is not limited to, a second good identifier and a buy location identifier, and
(c) determining with the processor of the computer system a match of the sell request and the buy request if (i) the first good identifier is the same as the second good identifier and (ii) the sell location identifier is the same as the buy location identifier.

An embodiment of the present invention is also directed to a method of exchanging goods that includes the steps of:
(a) receiving a sell request for a good, wherein the sell request includes, but is not limited to, a first good identifier,
(b) receiving a buy request for the good, wherein the buy request includes, but is not limited to, a second good identifier,
(c) placing the sell request in a holding queue wherein the sell request cannot be matched with the buy request,
(d) transmitting a quality inspection request to a quality inspector, wherein the quality inspection request includes an instruction to inspect the good,
(e) receiving a quality report from the quality inspector, wherein the quality report comprises a quality grade, and
(f) releasing the sell request from the holding queue if the quality grade is greater than or equal to a minimum quality value.

It should also be noted that step (b) of the method above may be performed in any order, that is, it may be performed before or after any of steps (a) or (c)-(f).

In a preferred embodiment, the method above is performed by a computer system over a network by the steps of:
(a) receiving over the network in the computer system a sell request for a good, wherein the sell request is encoded with data that includes, but is not limited to, a first good identifier,
(b) receiving over the network in the computer system a buy request for the good, wherein the buy request is encoded with data that includes, but is not limited to, a second good identifier,
(c) placing a flag on the sell request or storing the sell request in a queue database, wherein the flag or queue database indicates that the sell request cannot be matched with the buy request,
(d) transmitting from the computer system over the network a quality inspection request to a quality inspector, wherein the quality inspection request includes an instruction to inspect the good,
(e) receiving over the network in the computer system a quality report from the quality inspector, wherein the quality report comprises a quality grade, and
(f) removing the flag or transferring the sell request to an active database if the quality grade is greater than or equal to a minimum quality value, wherein the removal of the flag or active database indicates that the sell request can be matched with the buy request.

It should also be noted that step (b) of the method above may be performed in any order, that is, it may be performed before or after any of steps (a) or (c)-(f).

An embodiment of the present invention is further directed to a method of exchanging goods that includes the steps of:
(a) receiving a sell request for a good, wherein the sell request includes, but is not limited to, a first good identifier and a sell location identifier,
(b) receiving a buy request for the good, wherein the buy request includes, but is not limited to, a second good identifier and a buy location identifier,
(c) placing the sell request in a holding queue wherein the sell request cannot be matched with the buy request,
(d) transmitting a quality inspection request to a quality inspector, wherein the quality inspection request includes an instruction to inspect the good,
(e) receiving a quality report from the quality inspector, wherein the quality report comprises a quality grade,
(f) releasing the sell request from the holding queue if the quality grade is greater than or equal to a minimum quality value,
(g) determining a match of the sell request and the buy request if (i) the first good identifier is the same as the second good identifier and (ii) the sell location identifier is the same as the buy location identifier.

It should also be noted that step (b) of the method above may be performed before or after any of steps (a) or (c)-(f).

In a preferred embodiment, the method above is performed by a computer system over a network by the steps of:
(a) receiving over the network in the computer system a sell request for a good, wherein the sell request is encoded with data that includes, but is not limited to, a first good identifier and a sell location identifier,
(b) receiving over the network in the computer system a buy request for the good, wherein the buy request is encoded with data that includes, but is not limited to, a second good identifier and a buy location identifier,
(c) placing a flag on the sell request or storing the sell request in a queue database, wherein the flag or queue database indicates that the sell request cannot be matched with the buy request,
(d) transmitting from the computer system over the network a quality inspection request to a quality inspector, wherein the quality inspection request includes an instruction to inspect the good,
(e) receiving over the network in the computer system a quality report from the quality inspector, wherein the quality report comprises a quality grade,
(f) removing the flag or transferring the sell request to a live sell request database if the quality grade is greater than or equal to a minimum quality value, wherein the removal of the flag or live sell request database indicates that the sell request can be matched with the buy request, and
(g) determining with the processor of the computer system a match of the sell request and the buy request if (i) the first good identifier is the same as the second good identifier and (ii) the sell location identifier is the same as the buy location identifier.

It should also be noted that step (b) of the method above may be performed before or after any of steps (a) or (c)-(f).

In aspects of the present invention, the methods above may include additional steps of receiving a payment from the buyer and transmitting a payment to the seller and/or transmitting a transaction notification to the seller and the buyer providing the identifies and contact information of the buyer and seller. In an embodiment, the transaction notification my additionally or instead provide a transaction location designating where the seller is to deliver the good and the buyer is to pick up the good. These steps may also be performed by a computer system over a network.

An embodiment of the present invention is also directed to a method of tracking the depreciation of goods that includes the following steps:
(a) receiving a sell request for a good comprising a good identifier and a good quality grade value, wherein the good identifier has an associated good depreciation duration value,
(b) storing the good sell request with an associated timestamp representing a time the good sell request was activated or a time the good quality grade value was last decreased,
(c) determining a time difference between a current time and the timestamp and decreasing the good quality grade value by one unit if the time difference is greater than or equal to the good depreciation duration value.

In a preferred embodiment, the method above is performed by a computer system over a network by the steps of:
(a) receiving a sell request for a good comprising a good identifier and a good quality grade value, wherein the good identifier has an associated good depreciation duration value,
(b) storing the good sell request with an associated timestamp representing a time the good sell request was activated or a time the good quality grade value was last decreased,
(c) determining a time difference between a current time and the timestamp and decreasing the good quality grade value by one unit if the time difference is greater than or equal to the good depreciation duration value.

Thus, the methods described herein solve a particular problem unique to the e-commerce exchanging of goods or services. In particular, online goods or services provided by different merchants are not fungible and therefore require users to examine reviews or other metrics to determine quality. The methods described herein solve this problem by making the non-fungible goods or services into fungible commodities that can be efficiently transacted in e-commerce. For purposes of this art, a fungible service that is negotiated between two individuals can be transacted in this marketplace in exactly the same way as a good.

### BRIEF DESCRIPTION OF THE DRAWINGS

The present invention will be better understood when considered in view of the attached drawings. The drawings, however, are presented merely to illustrate the preferred embodiments of the invention without limiting the invention in any manner whatsoever.

FIG. 1 is a chart of various components of a goods exchange of the present invention, which in this instance is for fresh produce.

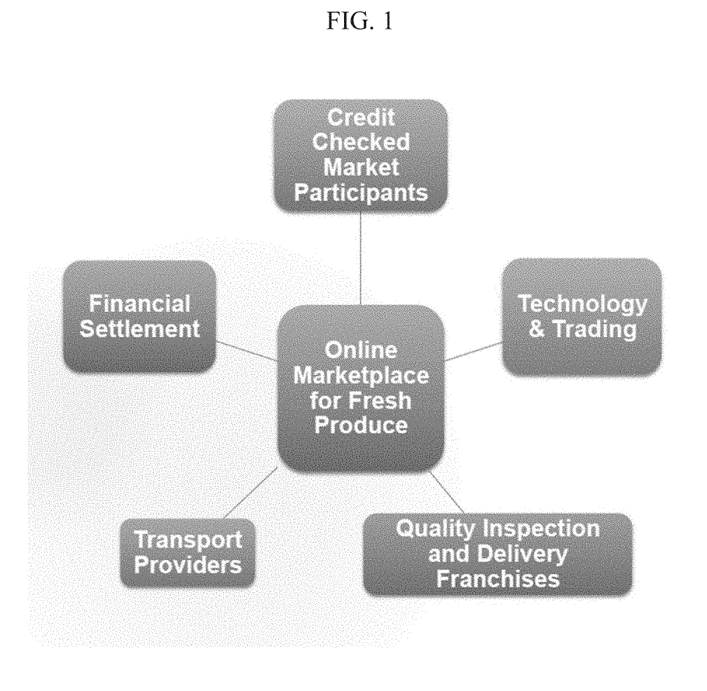

FIG. 2 depicts an example transaction showing the matching between sell requests and buy requests and particularly how the price in separate geographic areas may differ.

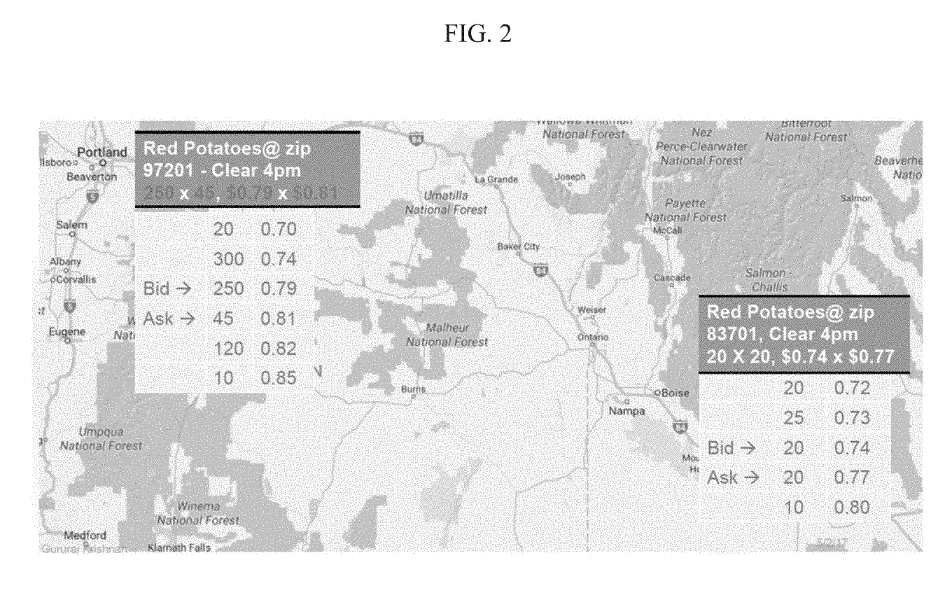

FIG. 3 is a chart depicting an exemplary operational workflow of the methods for operating an exchange of the present invention.

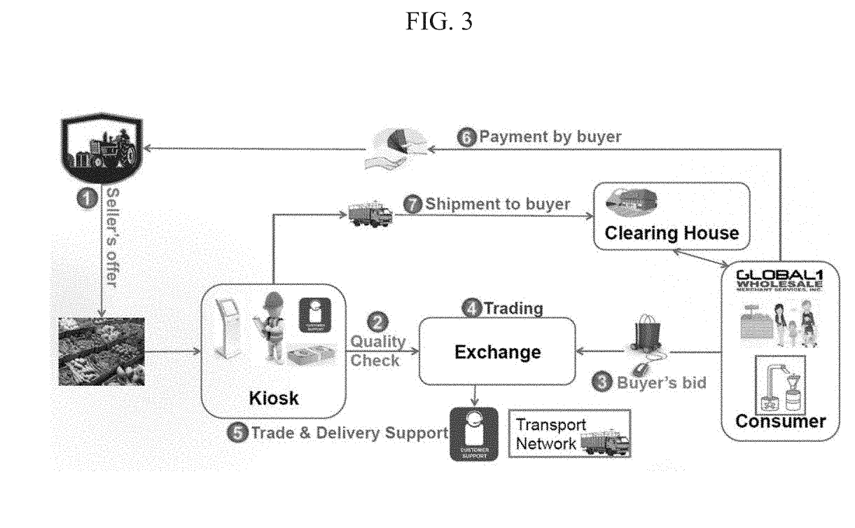

FIG. 4 is a chart comparing the variables involved with exemplary wholesale, retail, and liquidation markets of the exchange of the present invention.

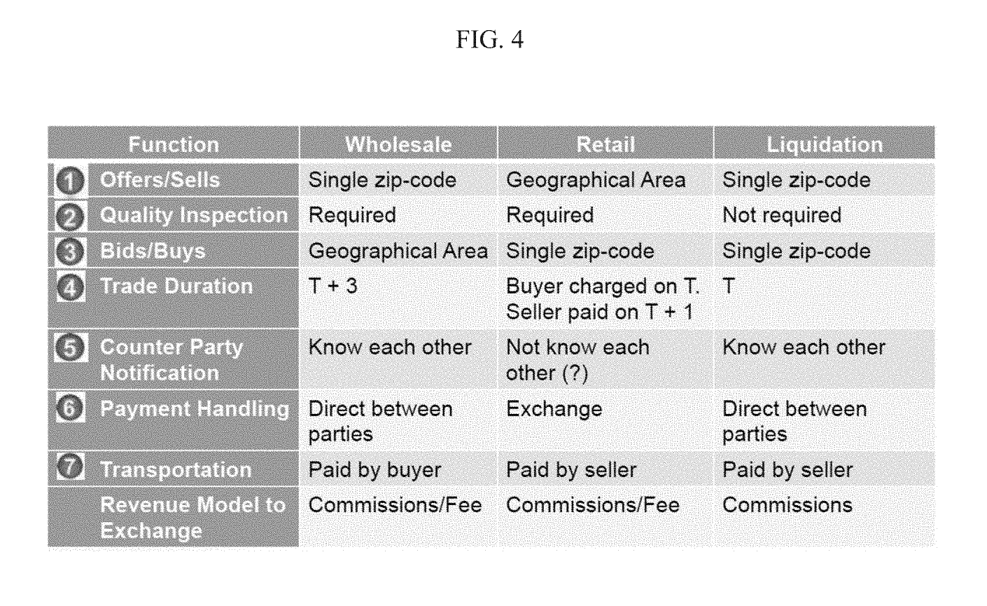

FIG. 5 is a chart outlining the value and benefits of the present invention.

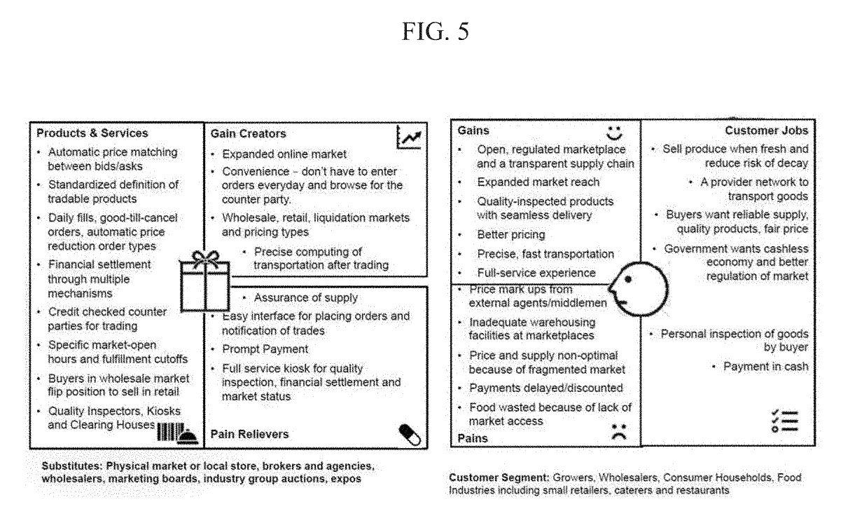

FIG. 6 is a chart outlining the operations and software platform of the present invention.

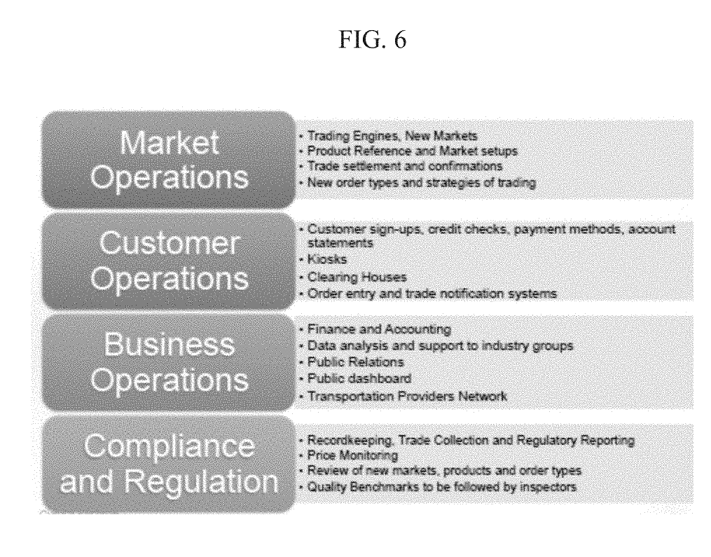

### DETAILED DESCRIPTION

The goods exchange of the present invention is preferably directed to an internet marketplace that operates similarly to a stock exchange for daily essentials, such as fresh produce and groceries, thereby providing the assurance of a fair price and transparency while also eliminating the need for supply chain intermediaries to facilitate a transaction.

At a general level, the goods exchange of the present invention functions by automatically matching buy and sell requests submitted by buyers and sellers of a particular good. A sell request may include any one or more of a good identifier, a seller identifier, a sell location identifier, a delivery distance value, a sell transfer time value, a good quality grade value, a good quantity value, a good ask price value, an order type, an order expiration time, and a transaction type. Similarly, a buy request may include any one or more of a good identifier, a buyer identifier, a buy location identifier, a pickup distance value, a buy transfer time value, a good quality grade value, a good quantity value, a good bid price value, an order type, an order expiration time, and a transaction type. A buy request may also include one or more seller identifiers if the buyer only wishes to transact with certain sellers. In some embodiments, the inclusion of the seller identifier in the sell request will indicate that the seller only wishes to transact with buyers who request the seller specifically.

The seller identifier and buyer identifier included in the sell and buy requests, respectively, may be any unique identifier, such as a numeric or alphanumeric sequence. In a preferred embodiment, the seller/buyer identifier corresponds to a user record that may be stored in a database in communication with a computer system. The user record may contain information about the seller/buyer including, but not limited to, name, address, email address, phone number, bank account information, account balance, delivery distance value, pickup distance value, sell location identifier, and buy location identifier.

A match between a buy and sell request may be determined by a comparison of the data included in the buy and sell requests. In embodiments, a match is determined if the good identifier of the sell request matches the good identifier of the buy request, which indicates that both the buyer and seller wish to transact the same type of good. Good types may be stored in a database that can include a good identifier, i.e., a unique identifier of the good type, such as an exchange symbol, a description of the good, a depreciation duration value for the good, and a quality grade of the good.

In an embodiment, a match may be determined by a comparison of the sell location identifier and the buy location identifier, i.e., a match may be determined if the sell location identifier and the buy location identifier are the same. In certain embodiments, the sell location identifier may include a set of a plurality of location identifiers, such as a set of zip codes, and the buy location identifier may include a set of a plurality or location identifiers, such as a set of zip codes. In this embodiment, a match may be determined by comparing if an element in the set of sell location identifiers is the same as an element in the set of buy location identifiers, i.e., the set of location identifiers intersects with the set of buy location identifiers.

In a particularly preferred embodiment, the buy and sell location identifiers are a set of location identifiers that includes a primary location identifier and one or more secondary location identifiers, preferably two, three, four, or five secondary location identifiers. The primary location identifier represents the location at which the buyer or seller resides or has a place of business and is the most preferred location for a transaction to occur. The secondary location identifiers represent other locations, usually adjacent or within close proximity of the primary location, at which the buyer or seller is willing to conduct a transaction. The secondary location identifiers may each have an associated score or weight representative of the buyer's or seller's willingness to conduct a transaction at the location, with a higher score or weight preferably representing a higher preference for the location.

Accordingly, a match between a buy and sell request may be determined when the primary location identifier of the buy and sell request is the same, when the primary location identifier of the buy request is the same as a secondary location identifier of the sell request and vice versa, and/or when a secondary location identifier of the buy or sell request is the same. Where there are multiple matching buy and sell requests (by item, price, and/or general location match), a “best match” may be determined by first comparing primary location identifiers. If the primary location identifiers do not match between any buy and sell requests then the next most suitable match may be determined by comparing primary location identifiers with secondary location identifiers by order of preference, and/or comparing secondary location identifiers by order of preference.

In a preferred embodiment, buy and sell requests are matched according to the following order of criteria: (1) matching primary location identifiers; (2) matching first-scored secondary location identifiers; (3) matching second-scored secondary location identifiers; (4) matching primary location identifier with first-scored secondary location identifier; (5) matching primary location identifier with second-scored secondary location identifier; and (6) matching first-scored secondary location identifier with second-scored secondary location identifier. In another preferred embodiment, criteria (4) may be ordered after criteria (1).

In another embodiment, if the primary location identifiers are not matched and a match is determined based on a match involving a secondary location identifier, the completion of the transaction may be delayed for an amount of time in the event that a request with a better match of location identifiers is received during the delay. In such a case, the original match is discarded in favor of the better match.

In an additional embodiment, a match may also be determined by a comparison of the sell location identifier and the buy location identifier along with a delivery distance value included in the sell request and a pickup distance value included in the buy request. That is, if the difference in distance between the sell location identifier and the buy location identifier is less than or equal to the delivery distance value of the seller and the pickup distance value of the buyer, then the sell request and buy request may be determined as a match. In embodiments, the delivery distance value and pickup distance value is an individual setting determined by buyers and sellers on the exchange, which is received, preferably over a network in a computer system, and stored as part of a user record, preferably in a database in communication with the computer system. In embodiments involving services performed at the home of the buyer, if the difference in distance between the sell location identifier and the buy location identifier is less than or equal to the delivery distance value of the seller, then the sell request and buy request may be determined as a match.

In another embodiment, the buy and sell requests do not include delivery/pickup distance values, but rather these values are preset by the exchange and stored in a database in communication with a computer system. Thus, a match may be determined if the difference in distance between the sell location identifier and the buy location identifier are within the preset distance range set by the exchange, such as 2 miles, 5 miles, 10 miles, 50 miles, or 100 miles.

In a further embodiment, a match may be determined when both the sell location identifier and the buy location identifier encompass a matching geographic area, such as a neighborhood, zip code, multizip code region, village/township/city, multivillage/township/city region, county, multicounty region, state, or multistate region, wherein the “multi” regions are preferably adjacent. Two geographic areas may be deemed a match if they overlap, either partially or fully. The geographic area may be preset by the exchange and stored in a database in communication with a computer system or may be set by the seller and buyer. In embodiments, a geographic area may be defined as a set of all zip codes encompassed by the geographic area. In these embodiments, a match may be determined, among other conditions, if the zip codes of the buyer and seller match an element of the set.

The buy and sell location identifiers may be any type of specific or general geolocation data known in the art. In a preferred embodiment, the buy and sell location identifiers are the respective postal codes, i.e., zip codes, of the buyer and seller. In other embodiments, the buy and sell location identifiers may be latitude/longitude coordinates, a street address, a city, a county, a state, or a country. The buy and sell location identifiers represent the geographic area(s) in which a buyer or seller is willing to fulfill transactions, i.e., make a pick up or delivery of goods. In an embodiment of the present invention the sell and buy requests contain a single zip code or address, and a set of zip codes is generated from the single zip code or address by determining all zip codes within a defined distance, such as 2, 5, 10, 20, or 50 miles, of the zip code or address included in the buy or sell request.

In an embodiment, the buy and sell location identifiers are not of equal scope, e.g., the buy location identifier may be a zip code, while the sell location identifier may be a city or county and vice versa. In this embodiment, a match is determined if the zip code falls within the total set of zip codes defined by the city or county. Stated generally, one of the buy or sell location identifiers may be an inferior region and the other being a superior region wherein a match is determined if the inferior region is encompassed by the superior region.

In a further embodiment, a match may also be determined by comparing an ask price included with the sell request and a bid price included with the buy request, wherein the ask price being less than or equal to the bid price indicates a match. In another embodiment, a match may be determined by a bid and ask price that are closest in proximity to one another relative to all other bid and ask prices submitted, i.e., the best bid and ask prices, with the actual price for the transaction being one of the bid price, ask price, or a midpoint of the bid and ask prices. In certain embodiments, the bid and ask prices must be equal in order for a match to be indicated. The bid and ask price aspect of the present invention functions similarly to a stock exchange. Thus, the sell and buy requests may also include an order type such as market order, day order, fill or kill order, stop order, limit order, all or none order, good-'til-cancelled order, and the like. Thus, as would be apparent to one skilled in the art, if the sell or buy request includes a market order type, the sell or buy request need not include an ask or bid price, respectively, as a market order indicates a desire to sell or buy at the best available price.

In an embodiment, the sell request may also include a sell transfer time value and/or the buy request may also include a buy transfer time value. The sell transfer time value may be a future timestamp, a time during the current day, a future date and time combination, or an amount of hours, minutes, and/or seconds from the current time representing when the seller will be able to deliver the goods or make them available for pickup. The buy transfer time value may be a future timestamp, a time during the current day, a future date and time combination, or an amount of hours, minutes, and/or seconds from the current time representing when the buyer will require the goods to be delivered or made available for pickup. The sell and buy transfer time values may also be a range of any of the foregoing time value types. In an embodiment of the present invention, a match may also be determined between a sell and buy request when the sell transfer time value included in the sell request is closer to the current time than the buy transfer time value included in the buy request, i.e., the seller can deliver or make available the goods prior to when the buyer requires them.

In an embodiment of the present invention, a match may also be determined by comparing good quality grade values included with the sell and buy requests. The good quality values may be representative of a particular differentiating quality class for a particular good type, such as grade-A, and/or indicative of a particular quality descriptor, such as organic, non-GMO, locally-sourced, responsibly-sourced, etc. In such embodiments, a match may be determined when the good quality grade values are the same.

The sell and buy requests may also include a good quantity value, i.e., the amount of the good that the seller wishes to sell and the buyer wishes to buy, respectively. In the event of mismatches between the quantity offered in a sell request and the quantity desired in a buy request, multiple sell requests or buy requests may be batched together, preferably by a computer system, to fulfill a buy or sell request. The batching may be performed by determining multiple matching sell or buy requests with a single buy or sell request, respectively, according to one or more of the criteria discussed above for determining a match.

The sell and buy requests may also include a transaction type identifier, such as wholesale, retail, or liquidation. Thus, in an embodiment of the present invention, a match may also be determined when the transaction type identifier of the sell and buy requests are the same.

The criteria above for determining a match may be employed individually or with any combination thereof being acceptable for the methods of the present invention. In a preferred embodiment, a match is determined first by determining that the good identifier of the buy request and the sell request is the same, then by determining that the good ask price is lower than the good bid price or determining that at least one of the buy request or sell request does not include a price, i.e., has an order type that is a market order, and then by determining that the location identifier of the buy request has a match with the location identifier of the sell request. In a further embodiment, the match is determined by then computing a market fairness coefficient. The market fairness coefficient seeks to ensure that a large buyer or seller is not dominating the exchange and may be calculated by factors such as the quantity of the request (larger quantities being given less preference), product movement velocity, previous transaction time of the same buyer or seller (buyer/sellers engaging in more recent transactions being given less preference), and/or partial match factors. Thus, an otherwise matching buy and sell request may be disregarded before completing the transaction based on any demotion caused by the market fairness coefficient.

The methods of the present invention may include placing a hold on the sell request, which may include placing the sell request in a holding queue, which is preferably a computer database in communication with a computer system, or placing a flag on the sell request until the goods offered by the sell request have passed a quality inspection. The holding queue or flag indicates that the sell request is pending and may not be matched with a buy request. In an embodiment, the holding queue may be present in a separate database from live sell requests or may be a separate table from the live sell requests that is part of the same database. In another embodiment, both live sell requests and pending sell requests may be present in the same database or database table by placing a flag on pending sell requests, which is preferably a binary value such as 0 or “false” that is placed in connection with a sell request.

The quality inspection is preferably performed by a third party independent service provider who has pre-registered with the exchange. A list of quality inspectors may be maintained in a database in communication with a computer system and may contain an inspection location identifier, an inspection travel distance value, the inspector's phone number, email, and/or user ID, and may also contain the inspector's name, address, and hourly rate or per job rate. Thus, in an embodiment of the present invention, when a sell request is submitted, the methods disclosed herein may also include the step of determining, preferably in a computer system, one or more nearby quality inspectors by comparing the inspection location identifier and optionally inspection travel distance value with the sell location value contained in the sell request and determining a match by using any of the methods discussed above for determining a match between a sell request location identifier and buy location request identifier. In addition, the inspection location identifier may be any of the types discussed above for the sell and buy location identifiers. The methods of the present invention may also include the step of transmitting a quality inspection request to one or more of the quality inspectors identified by the previous step, preferably from a computer system over a network. In an embodiment, the quality inspection request includes an instruction to inspect the good and may also include information such as the location of the good to be inspected, type of good to be inspected and/or description of the good to be inspected, and/or a unique identifier that is associated with a sample or batch of goods to be inspected. In an embodiment, the quality inspection request may be accepted or declined by any of the quality inspectors receiving the request, however, the quality inspection request will not be available for further acceptance after it is first accepted by one of the quality inspectors. Thus, the methods of the present invention also include the step of receiving an indication of acceptance of the quality inspection request from one of the quality inspectors.

After a quality inspector has accepted a quality inspection request, the quality inspector must travel to the location of the goods identified by the sell request or another location such as a kiosk or clearing house for the exchange and perform a physical inspection of all or a representative sample of the goods. The quality inspection ensures that the goods possessed by the seller are the same goods being offered on the exchange and that they meet a minimum quality value, which can represent the good quality grade value contained in the sell request or a threshold quality grade value required for listing on the exchange that is preset by the exchange. After the quality inspector determines this condition has been met, the quality inspector transmits a quality report that contains a quality grade. Thus, the methods of the present invention may also include the step of receiving a quality report from the quality inspector, wherein the quality report includes a quality grade. The quality report may also include a depreciation schedule for the good and/or a good confirmation indicating that the good inspected is the same good listed in the sell request. The quality grade may be numeric, e.g., from 1-10, alphabetical, e.g., from A-F or AAA-F, descriptive, e.g., either “high,” “medium,” or “low,” and/or binary, e.g., either “pass” or “fail.” In a preferred embodiment, the quality grade is binary, i.e., “pass” or “fail” or a similar designation. Thus, if the quality grade is “pass”, the sell request will be activated and available for matching with buy requests. However, if the quality grade is “fail”, the sell request will not be activated and will not be available for matching with buy requests.

In embodiments of the present invention, after the quality report is received from the quality inspector, the pending sell request will have the hold remove, e.g., be removed from the holding queue, i.e., transferred to the live sell request database or table, or the flag removed, if the quality grade contained in the quality report meets or exceeds the minimum quality value thereby allowing the sell request to be matched with matching buy requests. In an embodiment, if the quality grade contained in the quality report exceeds the minimum quality value, the quality grade in the sell request may be raised to equal the quality grade included in the quality report. In an embodiment, if the quality grade contained in the quality report is less than the minimum quality value, the sell request may be inactivated and voided or the quality grade included in the sell request may be lowered to equal the quality grade included in the quality report. In another embodiment, the sell request may be inactivated and voided if the good confirmation in the quality report indicates that the good inspected is not the same as the good listed in the sell request, or alternatively, the good identifier contained in the sell request may be modified to reflect the actual good that was inspected. In some embodiments of the present invention, the method may also include the step of transmitting a notification to the seller indicating that their goods passed quality inspection and will be listed live on the exchange.

The purchase, sale, or liquidation of fungible services functions the same as that of physical goods, whereby the quality inspection is the process of certifying the qualification and experience of the service provider. In embodiments of the present invention involving the exchange of services, the quality inspection may be receiving a report containing a quality grade from an independent rating agency. Alternatively, the quality report may be generated by the exchange according to an internal or external vetting of the service provider, the results of which may be stored in a database as a quality grade. As it relates to services, in addition to the metrics discussed above for goods, the quality grade may also contain an indication that the skills of the service provider meet a minimum threshold.

Embodiments of the present invention may also include additional steps after a match between a sell and buy request is determined. In one embodiment, the methods of the present invention include the step of receiving payment from the buyer, or receiving a transfer of payment from the buyer's bank, in the amount of the total price of the good (price×quantity) plus any applicable commissions, fees, or taxes. The methods of the present invention may also include the step of transferring payment to the seller, or transferring payment to the seller's bank, in the amount of the total price of the good (price×quantity) less any applicable commissions, fees, or taxes. In other embodiments, the method may include the step of transferring payment from the buyer, or the buyer's bank account, to the seller, or the seller's bank account, in the amount of the total price of the good (price×quantity) less any applicable commissions, fees, or taxes. In some embodiments, the payment from the buyer and to the seller occurs immediately and automatically upon determining a match between the sell and buy requests and is preferably performed by a computer system.

In another embodiment of the present invention, the methods include the step of transmitting a notification to the buyer and seller indicating that their respective buy and sell requests have been matched for trading. The notification may also contain the contact information for the buyer and seller so that the parties may contact each other to finalize the details of the transaction and make payment.

It should be apparent that upon a match being made between a sell and buy request, the sell and buy request are inactivated, i.e., no longer available for further matching. However, in certain embodiments, the sell or buy request may remain active if the quantity of the good that was matched in the sell and buy request is less than the good quantity value specified in the sell or buy request. Accordingly, in embodiments of the invention, the methods further include the step of transferring the buy and/or sell request to an inactive queue, or placing a flag on the buy or sell request designating it as inactive, or deleting the buy or sell request from the database after a match has been determined.

In some embodiments, upon closing a trade, i.e., a match between a sell and buy request is made and payment is transferred, if required, the goods can be delivered to the buyer's location. In another embodiment, the goods can be delivered to a clearing house for pick-up by the buyer or delivery from the clearing house to the buyer. The clearing house may be an existing store or vendor that act as a fulfillment center for the transactions. In a further embodiment, the goods may be made available for pickup at the seller's location. Thus, in an embodiment of the present invention, the method may further include the step of determining the place of delivery and/or pickup. In one embodiment, a clearing house is determined as the place of delivery and pickup by locating a clearing house that is within both the pickup distance value from the buy location identifier set in the buy request or the buyer's address, and the delivery distance value from the sell location identifier set in the sell request or the seller's address. In some embodiments, such as where the transaction type is wholesale or liquidation but need not necessarily be, the place of pickup may be the seller's address. In other embodiments, such as where the transaction type is retail but need not necessarily be, the place of delivery and pickup may be a clearing house that is located in the geographic area of the buyer and/or seller, for example, within, coextensive, or adjacent with the geographic area encompassed by the buy location identifier included in the buy request and/or sell location identifier included in the sell request. In embodiments of the present invention, a list of clearing house records may be maintained, preferably in a database in communication with a computer system. Each clearing house record may contain information such as a clearing house location identifier and/or clearing house address, and clearing house name. After an appropriate delivery and/or pickup location is determined, the methods of the present invention may also include the step of transmitting a notification to the seller and or buyer that contains the time or time range and place for delivery or pickup.

In embodiments of the invention, the delivery or pick up may be performed by a third party independent service provider for transportation who has pre-registered with the exchange. A list of transportation providers may be maintained in a database in communication with a computer system and may contain a transportation provider location identifier, a transportation provider travel distance value, the transportation provider's phone number, email, and/or user ID, and may also contain the transportation provider's name, address, and hourly rate or per job rate. Thus, in an embodiment of the present invention, when a sell request and buy request are matched, the methods disclosed herein may also include the step of determining, preferably in a computer system, one or more nearby transportation providers by comparing the transportation provider location identifier and optionally transportation provider travel distance value with the sell location value, buy location value, or clearing house location identifier and determining a match by using any of the methods discussed above for determining a match between a sell request location identifier and buy location request identifier. In addition, the transportation provider location identifier may be any of the types discussed above for the sell and buy location identifiers. The methods of the present invention may also include the step of transmitting a transportation request to one or more of the transportation providers identified by the previous step, preferably from a computer system over a network. In an embodiment, the transportation request includes an instruction to transport the goods from a first location to a second location and may also include information such as the type of good to be transported and/or description of the good to be inspected, quantity of good to be transported, and/or a unique identifier that is associated with a particular box, carton, bag, or the like that is to be delivered. In an embodiment, the transportation request may be accepted or declined by any of the transportation providers receiving the request, however, the transportation request will not be available for further acceptance after it is first accepted by one of the transportation providers. Thus, the methods of the present invention also include the step of receiving an indication of acceptance of the transportation request from one of the transportation providers.

In some embodiments, if a request is not matched by the end of the trading day, such as 4 PM, 4:30 PM, or 5 PM, the request will expire but may be resubmitted. It is also envisioned that in some embodiments a buy or sell request may include an order expiration time that may be a number of minutes, hours, days, weeks, months, or years, or a specific future date/time.

In preferred embodiments, the good identified in a sell or buy request is standardized with others of the same kind. In other words, each good identified in a sell or buy request is grouped with like goods based on its identity, wherein all goods within a group are considered identical and fungible. In an embodiment, this grouping is accomplished by assigning a particular good a tradeable identity, e.g., an exchange symbol, for use on the exchange. The tradeable identity or exchange symbol is preferably pre-set by the exchange and stored in a database in communication with a computer system and may be any unique identifier for the good, such as a short 3-, 4-, or 5-letter alphabetic identifier or a full generic description of the good, e.g., “GAPL” or “Green Apple.” It should be understood that services such as a home health-aide service, qualified plumber, physical therapy or any type of temporary daily contract labor, when provided with a tradable identity, can be transacted in the same way as physical/tangible goods in this art.

In an embodiment, the tradeable identity or exchange symbol is the primary source for identifying goods in the sell and buy requests. That is, when a sell or buy request is initiated, the seller or buyer indicates the type of good being sold or bought by reference to the tradeable identity or exchange symbol, which is preferably included in the sell or buy request. By using a tradeable identity or exchange symbol rather than other identifiers, the brand or source of the good becomes irrelevant to the transaction. Accordingly, the goods identifier of a buy or sell request represents the type or category of good but not the brand or source of good. Thus, for example, a seller desiring to sell green apples would identify the good in the sell request by the unique identifier, e.g. tradeable identity or exchange symbol, for green applies without including identifying information about the brand or source of the green apples. In an alternative embodiment, the exchange may allow trading of branded goods, where there are multiple sellers of the same brand and model by grouping like brand/models together under a single unique identifier, such as an exchange symbol. In such an embodiment, the goods may be standardized by reference to SKU data.

The standardization of goods on the exchange of the present invention removes needless friction and redundancies of current markets. For instance, rather than having various sellers all selling fungible items at their own price and according to their own supply chain, the exchange of the present invention will allow for a market price to be set for fungible goods. The market price represents the most recent price at which the good was last traded. Thus, in embodiments where exchanges are set up for each logical geographic area, such as zip code, county, city, state, etc., the market price for a particular good may be different among the different geographic areas due to different levels of supply and demand for the good in the area.

In certain embodiments, goods may be assigned depreciation schedules that are stored in a database in communication with a computer system. Different good types may have different associated depreciation schedules specific to the good type. In a preferred embodiment, the type of depreciation is loss of freshness, i.e., the freshness of the good decreases over time. In a preferred embodiment, the depreciation schedule is a depreciation duration value in the format of the number of hours, days, weeks, months, or years at which the good quality grade value should be decreased by one unit, though these values may be represented by seconds in a timestamp. The good quality grade value is a unit from a scale having a maximum unit, a minimum unit, and intermediate units at intervals between the maximum unit and minimum unit whereby a change from any unit on the scale to its immediately succeeding or preceding unit on the scale is a change of one unit. Thus, a one unit decrease in good quality grade refers to a change in the good quality grade to the immediate next unit on the scale closer to the minimum value. For example, on a scale from A-F, a one unit decrease would change the good quality grade from an A to a B or a D to an F. In embodiments of the present invention, if a good identified in a sell request has already been assigned the minimum unit of its quality grade scale, and the good's depreciation schedule calls for a decrease of the quality grade, the sell request will be inactivated and voided.

In an embodiment, the tracking of depreciation of a good may rely on timestamps, such as UNIX time timestamps. Thus, a sell request may be assigned a timestamp when it has been activated for trading, which in some embodiments is when the sell request is released from a holding queue or unflagged. This timestamp may then be compared to a current time at regular intervals, and if the time difference between the current time and the timestamp is greater than or equal to the depreciation duration value set forth in the associated depreciation schedule for the good, the quality grade of the sell request is decreased by one unit. Alternatively, the type of good identified in the sell request may be decreased by one unit, such as a change from grade-A green apples to grade-B green apples. In another embodiment, upon activation of a sell request, the sell request is assigned a future timestamp representing the time at which the quality grade should be decreased by one unit. The future timestamp may be calculated by adding the depreciation duration value set forth in the associated depreciation schedule for the good to the current time.

In another embodiment, the depreciation schedule may be an expiration date, which may be monitored as discussed above for monitoring a depreciation duration. At the expiration date, a sell request for an expired good may be inactivated and voided.

The methods of the present invention are suitable for operating an exchange for goods or services. The exchange may be for a specific type of good or service, category of goods or services, or theme and/or may be for a specific geographic area. The geographic area may be preset to a neighborhood, zip code, multizip code region, village/township/city, multivillage/township/city region, county, multicounty region, state, or multistate region, wherein the “multi” regions are preferably adjacent. In a preferred embodiment, the geographic area may be defined as a set of all zip codes encompassed by the geographic area. The exchange may have preset opening and closing hours, i.e., the hours during which active trading is permitted, or it may operate 24 hours a day. The exchange may also be limited to a specific type of market, such as wholesale, retail, or liquidation.

The present invention is therefore also directed to a method of initializing an exchange for goods that includes the steps of: (a) receiving a request to initialize an exchange, wherein the request includes a geographic area identifier, and wherein the geographic area identifier represents a set that encompasses one or more location identifiers; (b) storing the set in a database; and (c) activating an exchange website wherein a location identifier for a potential participant to a trade on the website must match at least one of the location identifiers in the set. The present invention is also directed to the operation of an exchange for a geographic area comprising the steps of: (a) receiving a sell or buy request for a good, wherein the sell or buy request includes a sell or buy location identifier; (b) rejecting the sell or buy request if the sell or buy location identifier does not match a set of location identifiers that correspond to the geographic area. In a preferred embodiment, the location identifiers are zip codes.

The present invention also includes additional criteria for determining whether to reject a buy or sell request such as determining whether a good identifier included in the sell or buy request is contained within a set of good identifiers representing the goods allowed to be traded on the exchange, determining whether the sell or buy request was received during a first time representing the opening of the exchange for trading and a second time representing the closing of the exchange for trading, determining whether an order expiration time included in the sell or buy request (time-in-force) is less than a depreciations duration value associated with the good identifier (i.e., orders cannot be open for a period longer than the time the associated good would depreciate to a lesser value or become worthless according to a depreciation schedule for the good), determining whether a quantity value included in the sell or buy request is within a minimum trade quantity value and a maximum trade quantity associated with an order type included in the sell request (e.g., in exchanges that allow retail transactions, the order quantity cannot exceed or be less than a preset ceiling and floor value that is appropriate for a retail market, and/or in exchanges that allow wholesale transactions, the order quantity cannot exceed or be less than a preset ceiling and floor value that is appropriate for a wholesale market), and determining whether a good ask price included in the sell request is within a minimum price tolerance and maximum price tolerance (the price tolerances are set by the exchange, preferably according to an algorithm, to prevent orders from moving the market or manipulating market prices).

The present invention is also directed toward a method of providing real-time price quotes for goods, such as produce or other groceries, that includes the steps of: (a) receiving a request for a price quote for a good wherein the request includes a unique identifier of the good; (b) retrieving, preferably from a database, a most recent trade that is associated with the unique identifier, wherein the most recent trade is associated with a price per unit at which the most recent trade occurred; (c) transmitting a price quote response, wherein the price quote response includes the price per unit.

It is also envisioned that a prospective buyer or seller will be able to use voice a command associated with an artificially intelligent assistant technology to obtain a price quote or initiate a buy or sell request for a particular good within a geographically defined area. Examples of current artificially intelligent assistant technology includes Amazon's Alexa, Apple's Siri, and Microsoft's Cortana.

The methods of the present invention may be performed by a computer system over any suitable computer network, such as the internet, with inputs being received for example from, mobile phones, smartphones, tablets, desktop computers, laptop computers, etc. It is also envisioned that buy and sell requests may be inputted into kiosks that are connected by a computer network, such as the internet, to the exchange. The kiosks are preferably located at the clearing houses where goods may be delivered and picked up. The kiosks may also be used to facilitate quality inspection requests and receive quality inspection reports, process payments, receive trade inquiries, facilitate transportation requests, handle storage for goods of completed orders, such as a locker system operated through the kiosk, and handle order fulfillment.

The computer system used in the methods of the present invention may contain a central processing unit (CPU) that executes computer programs stored on a memory. Memory in one embodiment comprises one or more levels of cache as desired to speed execution of the program and access to data on which the programs operate. The CPU is directly coupled to memory with both CPU and memory coupled to a bus. A storage, I/O and communications are also coupled to the bus. Storage is usually a long term storage device, such as a disk drive, tape drive, DVD, CD or other type of storage device.

In one embodiment, storage is used to house one or more databases for use with the present invention. I/O comprises keyboards, sound devices, displays and other mechanisms by which a user interacts with the computer system. Communications comprises a network, phone connection, local area network, wide area network or other mechanism for communicating with external devices. Such external devices comprise servers, other peer computers and other devices. In one embodiment, such external device comprises a database server that is used in place of the database on storage.

Other computer system architectures capable of executing software and interacting with a database and users may also be used. Additionally, appropriate security measures such as encryption are used to ensure confidentiality and data integrity and backup measures are used to prevent data loss.

It is noted that in the embodiments of the methods of the present invention discussed above, the steps may occur in any order or steps may be omitted or added as long as the overall workflow of the methods is not frustrated. All possible permutations and combinations of the above steps and any additional steps are also envisioned.

It is envisioned that any feature or element that is positively identified in this description may also be specifically excluded as a feature or element of an embodiment of the present invention as defined in the claims.

The invention described herein may be practiced in the absence of any element or elements, limitation or limitations which is not specifically disclosed herein. Thus, for example, in each instance herein, any of the terms “comprising,” “consisting essentially of” and “consisting of” may be replaced with either of the other two terms. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the claims.

### EXAMPLES

### Example 1

An exemplary wholesale market for produce may have the following workflow:

(1) Sellers enter pre-order tickets from their device to sell the produce. The order, i.e., sell request, has the quantity, availability time attributes, the offer zip-code, and price.

(2) The seller can bring the entire lot or a sample to a kiosk for inspection or the inspector will travel to the seller's site. The quality inspector checks the produce and releases the offer to the market.

(3) Wholesalers and other buyers browse the market and enter buy orders.

(4) The market operates, data is published, and trades are notified to the parties.

(5) Optimal transport routes are computed for trades and buyers are recommended about providers and price quotes. The buyer finalizes transportation, contacts the seller to schedule the payment and schedule the produce pickup.

(6) The buyer completes the payment directly to the seller within three days of the transaction.

(7) The seller ships the product through the buyer-arranged transportation.

### Example 2

An exemplary retail market for produce may have the following workflow:

(1) Sellers enter pre-order tickets to sell their produce. Buyers in wholesale markets can flip their position and sell into to the retail market.

(2) Produce is inspected by inspector(s) available at regional market locations or at a clearing house. They also may travel to seller's site.

(3) Buyers enter bids, i.e., buy requests, with order type, quantity, price and geo-location.

(4) The market operates, data is published, and trades are notified to the parties. The produce must be delivered by the seller to the buyer's clearing house.

(5) The daily settlement process includes preparing delivery reports for the clearing houses about their incomings and buyer info, and transport routes from the sellers' origins to the destinations.

(6) The buyer is charged through an online payment mechanism. The seller is paid next day and clearing houses are paid on a monthly basis.

(7) The seller delivers the produce to the clearing house from where the buyer picks it up.

1. A method of exchanging goods over a computer network comprising the steps:
(a) receiving over the network in a computer system a sell request, wherein the sell request contains a first good identifier,
(b) receiving over the network in the computer system a buy request, wherein the buy request contains a second good identifier,
(c) placing a hold on the sell request, wherein the hold indicates that the sell request cannot be matched with the buy request,
(d) transmitting from the computer system over the network a quality inspection request to a quality inspector,
(e) receiving over the network in the computer system a quality report from the quality inspector, wherein the quality report comprises a quality grade, and
(f) removing the hold from the sell request if the quality grade is greater than or equal to a minimum quality value, wherein the removal of the hold indicates that the sell request can be matched with the buy request.

2. The method of claim 1 wherein the sell request further comprises a good ask price value and a first good quantity value and the buy request further comprises a good bid price value and a second good quantity value.

3. The method of claim 2 wherein the sell request further comprises a sell location identifier and the buy request further comprises a buy location identifier.

4. The method of claim 3 wherein the sell location identifier and buy location identifier are each a zip code or a set of zip codes.

5. The method of claim 1 wherein the hold is a flag on the sell request or storing the sell request in a holding queue.

6. The method of claim 1 wherein the first good identifier of the buy request and the second good identifier of the sell request represent a type of the good without regard to a source of the good.

7. A method of exchanging goods over a computer network comprising the steps:
(a) receiving over the network in the computer system a sell request for a good, wherein the sell request contains a first good identifier and a sell location identifier,
(b) receiving over the network in the computer system a buy request for the good, wherein the buy request contains a second good identifier and a buy location identifier,
(c) placing a hold on the sell request, wherein the hold indicates that the sell request cannot be matched with the buy request,
(d) transmitting from the computer system over the network a quality inspection request to a quality inspector, wherein the quality inspection request includes an instruction to inspect the good,
(e) receiving over the network in the computer system a quality report from the quality inspector, wherein the quality report comprises a quality grade,
(f) removing the hold from the sell request if the quality grade is greater than or equal to a minimum quality value, wherein the removal of the hold indicates that the sell request can be matched with the buy request, and
(g) determining with the processor of the computer system a match of the sell request and the buy request if (i) the first good identifier is the same as the second good identifier and (ii) the sell location identifier overlaps with the buy location identifier.

8. The method of claim 7 wherein the sell request further comprises a good ask price value and a first good quantity value and the buy request further comprises a good bid price value and a second good quantity value.

9. The method of claim 8 wherein a match is further determined if (iii) the good bid price value is greater than or equal to the good ask price value.

10. The method of claim 7 wherein the sell location identifier and buy location identifier are each a zip code or a set of zip codes.

11. The method of claim 7 wherein the hold is a flag on the sell request or storing the sell request in a holding queue.

12. The method of claim 7 wherein the first good identifier of the buy request and the second good identifier of the sell request represent a type of the good without regard to a source of the good.

13. A method of exchanging services over a computer network comprising the steps:
(a) receiving over the network in the computer system a sell request for a service, wherein the sell request contains a first service identifier and a sell location identifier,
(b) receiving over the network in the computer system a buy request for the service, wherein the buy request contains a second service identifier and a buy location identifier,
(c) placing a hold on the service request, wherein the hold indicates that the sell request cannot be matched with the buy request,
(d) retrieving a quality report from a database, wherein the quality report comprises a quality grade,
(e) removing the hold from the sell request if the quality grade is greater than or equal to a minimum quality value, wherein the removal of the hold indicates that the sell request can be matched with the buy request, and
(f) determining with the processor of the computer system a match of the sell request and the buy request if (i) the first service identifier is the same as the second service identifier and (ii) the sell location identifier overlaps with the buy location identifier.

14. The method of claim 13 wherein the sell request further comprises a service ask price value and the buy request further comprises a service bid price value.

15. The method of claim 14 wherein a match is further determined if (iii) the service bid price value is greater than or equal to the service ask price value.

16. The method of claim 13 wherein the sell location identifier and buy location identifier are each a zip code or a set of zip codes.

17. The method of claim 13 wherein the hold is a flag on the sell request or storing the sell request in a holding queue.

18. The method of claim 13 wherein the first service identifier of the buy request and the second service identifier of the sell request represent a type of the service without regard to a source of the service.
